(19) United States
(12) Patent Application Publication
(10) Pub. No.: US 2012/0133593 A1
(43) Pub. Date: May 31, 2012

(54) DIGITIZER FOR A FINGERTIP TACTILE-SENSE INPUT DEVICE

(75) Inventors: Takuro Nakayama, Tokyo (JP); Atsuhide Yoshida, Kanagawa (JP); Toyonaru Tanaka, Kanagawa (JP)

(73) Assignee: I'M CO., LTD., Fukuoka (JP)

(21) Appl. No.: 12/672,562

(22) PCT Filed: Aug. 6, 2008
(86) PCT No.: PCT/JP08/64497

§ 371 Date: Feb. 9, 2012

(30) Foreign Application Priority Data
Aug. 7, 2007 (JP) 2007-205562

(51) Int. Cl. G06F 3/041

(52) U.S. Cl. 345/173

(57) ABSTRACT

The present invention provides a digitizer for a fingertip tactile-sense input device to which switches can be added without having to increase the number of wires. A first lower right contact (33b) and a second lower right contact (33c) are placed respectively on the first and second resistive sheets (10a, 20a) at specified positions that are separated to the right from the control area (11, 21) so that they form a lower right switch (33), with the first lower right contact (33b) being connected to the bottom edge electrode (11b) and the second lower right contact (33c) being connected to the right edge electrode (21a); and a first upper left contact (34b) and a second upper left contact (34c) are placed respectively on the first and second resistive sheets (10a, 20a) at specified positions that are separated to the left from the control area (11, 21) so that they form the upper left switch (34), with the first upper left contact (34b) being connected to the top edge electrode (11a) and the second upper left contact (34c) being connected to the left edge electrode (2b).

The present invention relates to a digitizer that is used in a fingertip tactile-sense input device for inputting numbers, text, graphics, or position information to a compact electronic device such as a personal digital assistant, which include a mobile phone, a remote controller, a mobile audio player, a mouse, an electronic notebook, a gaming device or a medical device, by using the sense of touch of a person's fingertip.

Currently, the popularity of compact electronic devices such as personal digital assistants has become remarkable, and as these compact electronic devices become even more compact, the input devices that are used in these devices must also become more compact. Moreover, the exchange of information via these kinds of compact electronic devices is becoming more complex, so not only must the input devices thereof become more compact, but they must also be capable of easily performing complex information processing.

Fingertip tactile-sense input devices are being developed as input devices that are to be used in compact electronic devices, and they comprise a plurality of keys in a narrow range in which a person's fingertip moves, such that input is performed by selecting and pressing a key with a fingertip, causing a switch to conduct. More specifically, technology for a device comprising a plurality of keys that selects and processes input information is disclosed in Japanese Patent No. 3,708,508 (U.S. Pat. No. 7,280,101; WO 03019373). In this fingertip tactile-sense input device, the operator feels the keys that are protrusions from the surface of the input device, and in order that desired input information can be given, the operator moves his/her fingertip while referencing information that is displayed on the screen to select keys corresponding to the switches, and performs input by pressing a switch.

Compared to conventional key-button type input devices, this fingertip tactile-sense input device is capable of quick and simple input of complex information, as well as has brought about dramatic miniaturization of input devices for compact electronic devices and the like, with further development expected in the future.

### SUMMARY OF THE INVENTION

In order to improve the convenience of the fingertip tactile-sense input device described above, the inventors have proposed a fingertip tactile-sense input device that comprises: one dome spring, one switch, a digitizer that is located providing with two resistive sheets and having construction such that at a position that exceeds a specified load, there is electrical conduction between both principal surfaces of the resistive sheets, and a rigid actuator that causes the dome switch to operate (refer to Japanese Patent Application No. 2007-194661). Together with making it possible to make the fingertip tactile-sense input device more compact and thinner, and allow smooth key input having a clicking feel, mass productivity of the device is improved.

With this kind of input device, key selection is made possible by the digitizer processing fingertip position information. Each of the resistive sheets that are used in this digitizer comprise planar resistive elements, and at a position where the touch from a fingertip exceeds a specified load, an electrical conductive state occurs between both principal surfaces of the planar resistive elements, which makes it possible to identify the fingertip position. More specifically, electrodes are arranged on both sides in the X direction (horizontal direction) of one of the planar resistive elements, and electrodes are also arranged on both sides in the Y direction (vertical direction) of the other planar resistive element, so that the position can be identified by measuring the resistance value in both directions. Therefore, it is necessary that parallel current uniformly flow in these planar resistive elements, and by attaching parallel electrodes on two opposing edges of the respective planar resistive elements, the outline shape of the element is limited to being a square or rectangle.

On the other hand, the required control area for an input device is not limited to a rectangular shape and often it is rounded as in a circle, ellipse or oval, and when trying to layout a round operation area in a square or rectangular digitizer as described above, problems exist in that wasted space occurs in the surrounding area, the effective operation area is decreased, and the device becomes more difficult to use.

Therefore, switches are possible in which 12 to 16 keys that will be the fundamental key are arranged on areas where the planar resistive elements are located, and all other keys are arranged on the surrounding space on the resistive sheet, with contact points being provided on both sheets. In this case, for the planar resistive elements, it is necessary to have two wires for each of the two resistive sheets for a total of four wires, however, by further adding two more keys, it is necessary to have two wires on each of the two resistive sheets for both keys, for another total of 4 wires, and thus the number of wires connected to the digitizer increases. When the number of wires increases, it is no longer possible to use a conventional controller semiconductor that was used in a conventional digitizer having only 4 or 5 wires, so it becomes necessary to design and produce a new controller semiconductor.

In this fingertip input device, an actuator is used, and by pressing a dome spring the user can select and perform input having a clicking feel, however, there is a problem in that as the number of wires increases, the preferred operation of the actuator is hindered.

The object of the present invention is to provide a digitizer for a fingertip tactile-sense input device to which keys can be added without having to increase the number of wires, and without affecting the operation of the actuator.

One form of a digitizer for a fingertip tactile-sense input device of the present invention comprises: two resistive sheets positioned so as to face each other; planar resistive elements that are arranged on opposing surfaces of the two resistive sheets; contacts that are formed on opposing surfaces of the two resistive sheets at locations where the planar resistive elements are not arranged; electrodes that are attached to each of the two opposing edges of the planar resistive elements such that the current direction is perpendicular to each other; and a wiring pattern that connects the contacts and electrodes to external elements; wherein

the planar resistive elements face each other via an intermediate structure such that they are in an electrically conductive state at a position that exceeds a specified load, and the wiring pattern is formed so that, when at least one of the contact conducts current, an electrical response is obtained that is the same as when one of the four corners of the planar resistive elements or any specified position along the four edges is in a conductive state.

More specifically, the digitizer for a fingertip tactile-sense input device of the present invention comprises two resistive sheets, with an intermediate structure being placed between the resistive sheets in a square or rectangular control area so that the resistive sheets are in an electrically conductive state at a position that exceeds a specified load.

A square or rectangular planar resistive element that is the same size as or larger than the control area is attached to each of the resistive sheets at the control area on the opposing side.

Two electrodes are attached to each of the planar resistive elements on two opposing edges so that the current direction is perpendicular to each other.

Also, one or more keys are arranged on each of the resistive sheets at specified positions that are separated from the control area, and the key wiring is arranged such that by controlling that key/keys, an electrical response is obtained that is the same as when one of the four corners or any specified position along the four edges of the planar resistive elements is in a conductive state.

An embodiment of a digitizer for a fingertip tactile-sense input device of the present invention comprises: a first resistive sheet and a second resistive sheet, with an intermediate structure being placed between the first resistive sheet and the second resistive sheet in square or rectangular control area that is surrounded by a top edge, right edge, bottom edge and left edge so that they are in an electrically conductive state at a position that exceeds a specified load; wherein

a square or rectangular first planar resistive element that is the same size as or larger than the control area is attached to the first resistive sheet at the control area on a side that faces the second resistive sheet, and a square or rectangular second planar resistive element that is the same size as or larger than the control area is attached to the second resistive sheet at the control area on a side that faces the first resistive sheet;

with a top edge electrode being attached to the top edge of the first planar resistive element, a bottom edge electrode being attached to the bottom edge of the first planar resistive element, a right edge electrode being attached to the right edge of the second planar resistive element, and a left edge electrode being attached to the left edge of the second planar resistive element; and

one or more switches are placed on both the first resistive sheet and second resistive sheet at specified positions separated from the control area, and a wiring pattern for connecting the electrodes and contacts with external elements is formed so that by controlling the switch/switches an electrical response is obtained that is the same as when one of the four corners or any specified position along the four edges of the planar resistive elements is in a conductive state.

Moreover, the intermediate structure is a structure in which insulation sections are dispersed in a patchy or random shape, and at a position where the space between the insulation sections is pressed down, the first planar resistive element and second planar resistive element conduct, or more preferably, the intermediate structure is a structure that conducts when pressed or touched at a prescribed pressure or above.

Furthermore, the switches comprise a lower right switch and an upper left switch, where it is preferred that

a first lower right contact and a second lower right contact are placed respectively on the first resistive sheet and second resistive sheet at specified positions that are separated to the right from the control area such that they face each other to form the lower right switch, with the first lower right contact being connected to the bottom edge electrode and the second lower right contact being connected to the right edge electrode; and

a first upper left contact and a second upper left contact are placed respectively on the first resistive sheet and second resistive sheet at specified positions that are separated to the left from the control area such that they face each other to form the upper left switch, with the first upper left contact being connected to the top edge electrode and the second upper left contact being connected to the left edge electrode.

Alternatively, the keys can also comprise an upper right switch and an upper left switch, where it is preferred that

a first upper right contact and a second upper right contact are placed respectively on the first resistive sheet and second resistive sheet at specified positions that are separated to the right from the control area such that they face each other to form the upper right switch, with the first upper right contact being connected to the top edge electrode and the second upper right contact being connected to the right edge electrode; and

a first upper left contact and a second upper left contact are placed respectively on the first resistive sheet and second resistive sheet at specified positions that are separated to the left from the control area such that they face each other to form the upper left switch, with the first upper left contact being connected to the top edge electrode and the second upper left contact being connected to the left edge electrode.

Alternatively, the keys can also comprise an upper right switch, a lower right switch, an upper left switch and a lower left switch, where it is preferred that

a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode and the second upper right contact being connected to the right edge electrode;

a first lower right contact and a second lower right contact are placed respectively on the first resistive sheet and second resistive sheet at specified positions that are separated to the lower right from the control area such that they face each other to form the lower right switch, with the first lower right contact being connected to the bottom edge electrode and the second lower right contact being connected to the right edge electrode;

a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode and the second upper left contact being connected to the left edge electrode; and

a first lower left contact and a second lower left contact are placed respectively on the first resistive sheet and second resistive sheet at specified positions that are separated to the lower left from the control area such that they face each other to form the lower left switch, with the first lower left contact being connected to the bottom edge electrode and the second lower left contact being connected to the left edge electrode.

Alternatively, the keys can also comprise an upper right switch, a lower right switch, an upper left switch and a lower left switch, where it is preferred that

a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode and the second upper right contact being connected to the right edge electrode;

a first lower right contact and a second lower right contact are placed respectively on the first resistive sheet and second resistive sheet at specified positions that are separated to the lower right from the control area such that they face each other to form the lower right switch, with the first lower right contact being connected to the first upper right contact via a right resistance, and the second lower right contact being connected to the right edge electrode;

a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode, and the second upper left contact being connected to the left edge electrode; and

a first lower left contact and a second lower left contact are placed respectively on the first resistive sheet and second resistive sheet at specified positions that are separated to the lower left from the control area such that they face each other to form the lower left switch, with the first lower left contact being connected to the first upper left contact via a left resistance, and the second lower left contact being connected to the left edge electrode.

Alternatively, the keys can also comprise an upper right switch, a middle right switch, a lower right switch, an upper left switch, a middle left switch and a lower left switch, where it is preferred that

a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode, and the second upper right contact being connected to the right edge electrode;

a first middle right contact and a second middle right contact are placed respectively on the first resistive sheet and second resistive sheet at specified positions that are separated to the middle right from the control area such that they face each other to form the middle right switch, with the first middle right contact being connected to the first upper right contact via an upper right resistance, and the second middle right contact being connected to the right edge electrode;

a first lower right contact and a second lower right contact are placed respectively on the first resistive sheet and second resistive sheet at specified positions that are separated to the lower right from the control area such that they face each other to form the lower right switch, with the first lower right contact being connected to the first middle right contact via a lower right resistance, and the second lower right contact being connected to the right edge electrode;

a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode and the second upper left contact being connected to the left edge electrode;

a first middle left contact and a second middle left contact are placed respectively on the first resistive sheet and second resistive sheet at specified positions that are separated to the middle left from the control area such that they face each other to form the middle left switch, with the first middle left contact being connected to first upper left contact via an upper left resistance, and the second middle left contact being connected to the left edge electrode; and

a first lower left contact and a second lower left contact are placed respectively on the first resistive sheet and second resistive sheet at specified positions that are separated to the lower left from the control area such that they face each other to form the lower left switch, with the first lower left contact being connected to the middle left contact via a lower left resistance, and the second lower left contact being connected to the left edge electrode.

Moreover, it is preferred that the digitizer for a fingertip tactile-sense input device of the present invention further comprises: a tail section having one end of the length direction that is sandwiched between and fixed to a part of the first resistive sheet and a part of the second resistive sheet; and a required number of electrode pads provided on each of terminations of the respective wiring patterns of the first resistive sheet and second resistive sheet and the both sides of the one end of the tail section, the electrode pads which face each other being connected electrically to each other.

Furthermore, it is preferred that the tail section is a flexible substrate, wherein a part of the tail section which is adjacent or near to the connecting section with the first resistive sheet and second resistive sheet has a width narrower than the other part.

The fingertip tactile-sense input device of the present invention comprises any of the digitizers for a fingertip tactile-sense input device described above, and a top surface sheet, and outputs information about the position that is pressed the hardest and the operated key.

The mobile telephone, personal digital assistant, personal computer input device, home appliance, remote controller, gaming device and medical device of the present invention comprise the aforementioned fingertip tactile-sense input device, and display information about the position that is pressed the hardest and the operated key.

The terms upper, lower, right and left are for clarifying the relative positional relationship, and any technique that has an equivalent function due to rotation and symmetry are included in the present invention. Moreover, the layout of electrodes, contacts and wirings on the first and second resistive sheets can be reversed.

With the digitizer for a fingertip tactile-sense input device of the present invention, it is possible to obtain the remarkable effect of being able to add keys without having to increase the number of wires, which had to be increased in the case of the related art, and it is possible to perform the same position detection processing using the same wiring, which was used in a conventional digitizer, in a conventionally used controller semiconductor.

Furthermore, the present invention can also be applied to a well-known touch panel, switch with a display function, or the like.

### BRIEF DESCRIPTION OF THE DRAWINGS

FIG. 1 is a top view of a first embodiment of a digitizer for a fingertip tactile-sense input device of the present invention, and shows (a) a top surface sheet, (b) a first resistive sheet and (c) a second resistive sheet.

FIG. 2 is a top view of a second embodiment of a digitizer for a fingertip tactile-sense input device of the present invention, and shows (a) a top surface sheet, (b) a first resistive sheet and (c) a second resistive sheet.

FIG. 3 is a top view of a third embodiment of a digitizer for a fingertip tactile-sense input device of the present invention, and shows (a) a top surface sheet, (b) a first resistive sheet and (c) a second resistive sheet.

FIG. 4 is a top view of a fourth embodiment of a digitizer for a fingertip tactile-sense input device of the present invention, and shows (a) a top surface sheet, (b) a first resistive sheet and (c) a second resistive sheet.

FIG. 5 is a top view of a fifth embodiment of a digitizer for a fingertip tactile-sense input device of the present invention, and shows (a) a top surface sheet, (b) a first resistive sheet and (c) a second resistive sheet.

FIG. 6 shows an embodiment of the fingertip tactile-sense input device to which the digitizer of the present invention is applied.

FIG. 7 shows an embodiment of the fingertip tactile-sense input device to which the digitizer of the present invention is applied.

FIG. 8 shows an embodiment of the fingertip tactile-sense input device to which the digitizer of the present invention is applied.

FIG. 9 shows an embodiment of the fingertip tactile-sense input device to which the digitizer of the present invention is applied.

FIG. 10 is a drawing for the case in which an embodiment of the fingertip tactile-sense input device to which the digitizer of the present invention is applied, and shows the key arrangement that is displayed on the display of a compact electronic device, and recognition position for each key.

FIG. 11 shows an example of the first embodiment shown in FIG. 1, and shows (a) a top view, (b) a cross sectional view along the line A-A′, and (c) a cross sectional view along the line A-A′ which includes a section along the line A-A″.

FIG. 12 shows an example of a sixth embodiment of the present invention, and shows (a) a top view of a top surface sheet, (b) a top view of a first resistive sheet, (c) a top view of a second resistive sheet, (d) a tail section as an element separated from the second resistive sheet, and (e) a state where the first resistive sheet, the second resistive sheet and the tail section are assembled.

FIG. 13(a) shows a cross sectional view of the embodiment shown in FIG. 12, and FIG. 13(b) shows another cross sectional view similar to FIG. 13(a) but it includes partly a section where the connecting section of the electrode pads are formed.

### REFERENCE NUMBERS

Digitizer
2 Actuator
3 Convex section
4 Dome spring
5 Switch mechanism
10a 10b, 10c, 10d, 10e First resistive sheet
11 Control area
11a Upper edge electrode
11b Lower edge electrode
20a, 20b, 20c, 20d, 20e Second resistive sheet
21 Control area
21a Right edge electrode
21b Left edge electrode
30a, 30b, 30c, 30d, 30e Top surface sheet
31 Upper right switch (right switch)
31a Upper right resistance
31b First upper right contact
31c Second upper right contact
32 Middle right switch
32a Right resistance
32b First middle right contact
32c Second middle right contact
33 Lower right switch (right switch)
33a Lower right resistance
33b First lower right contact
33c Second lower right contact
34 Upper left switch (left switch)
34a Upper left resistance
34b First upper left contact
34c Second upper left contact
35 Middle left switch
35a Left resistance
35b First middle left contact
35c Second middle left contact
36 Lower left switch
36a Lower left resistance
36b First lower left contact
36c Second lower left contact
37 Top surface protrusions
38, 38a Connective pad
39, 39a Connective pad
40 Tail section
40a narrower section
40b, 40c Connective pad
41 Upper right key (right key)
42 Middle right key
43 Lower right key (right key)
44 Upper left key (left key)
45 Middle left key
46 Lower left key
50 Casing (upper casing)
50b Lower casing
61 Switch board

### BEST MODE FOR CARRYING OUT THE INVENTION

First, an overview of the fingertip tactile-sense input device to which the digitizer for a fingertip tactile-sense input device of the present invention is applied will be explained.

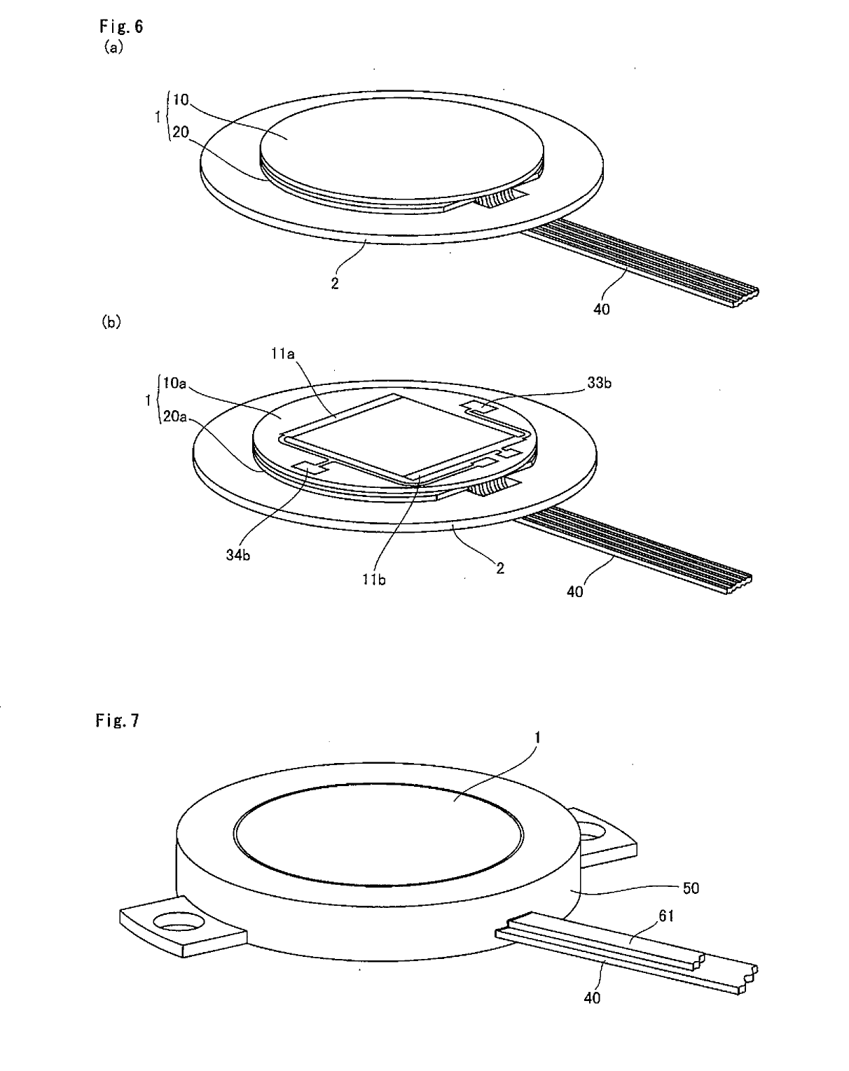

FIG. 6 to FIG. 9 show an embodiment of a fingertip tactile-sense input device to which the fingertip tactile-sense input device of the present invention is applied. This embodiment is an example in which the fingertip tactile-sense input device is packaged in a casing, however, this fingertip tactile-sense input device can also be provided directly in the compact electronic device using the frame or the like of this device.

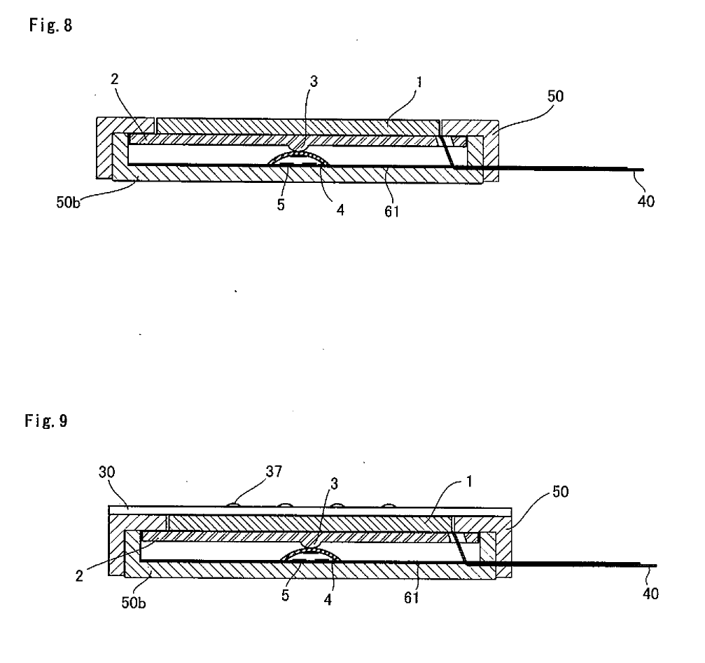

FIG. 6(a) is a perspective view showing the state in which the digitizer (1) for a fingertip tactile-sense input device of the present invention is combined with the actuator (2) of the fingertip tactile-sense input device. Also, FIG. 6(b) is a similar perspective view that shows the pattern formed on the resistive sheet (10) of the digitizer (1). FIG. 7 is a perspective view showing an example of a fingertip tactile-sense device in which the digitizer (1) and actuator (2) are packaged in a casing (50, 50b) together with a dome spring (4) and input-confirmation-switch mechanism (5). FIG. 8 is a cross-sectional view showing the internal construction of the fingertip tactile-sense input device shown in FIG. 7, and FIG. 9 is a cross-sectional view showing construction in which there is a top surface sheet (30) on the surface of the fingertip tactile-sense input device shown in FIG. 8.

This embodiment of the invention comprises an upper casing (50), a lower casing (50b), a top surface sheet (30), a digitizer (1) and an actuator (2).

A flange is formed around the circumferential direction on the upper surface of the upper casing (50), with an opening space formed in the center. Moreover, the lower casing (50b) forms a bottom plate and fits inside the upper casing (50).

One dome spring (4) is located in the center on the top side of the lower casing (50b). A switch structure (5) is formed on the inside of the dome spring (4). The material of the dome spring (4) is selected from a material having high durability and impact resistance such as metal, resin or the like. Moreover, the switch structure (5) is constructed so that the metal dome spring (4) functions as one contact, with one or two contacts at opposing positions, so that by deforming the dome spring (4), the switch transitions between a non-conductive state and conductive state. Furthermore, by providing a convex section or protrusion (3) on the structure that faces the dome spring (4), a very suitable clicking feeling can be obtained.

As shown in FIG. 6, the digitizer (1) comprises a first resistive sheet (10) and second resistive sheet (20), with a tail section (40) being formed on the second resistive sheet (20), and the digitizer (1) is connected to external elements by wiring that is formed on the tail section (40). This will be explained in more detail later, however, planar resistance elements (11c, 21c) are located in the center sections on the opposing surfaces of the first resistive sheet (10) and second resistive sheet (20), and electrodes (11a, 11b) are formed on both sides in the up and down direction of the planar resistive element on the first resistive sheet (10). On the other hand, electrodes (21a, 21b) are formed on both sides in the left and right direction of the planar resistive element on the second resistive sheet (20). Moreover, as necessary, contacts (31b to 36b) and resistance (31a to 36a) are formed on part of both resistive sheets, with a respective wiring pattern being formed on each resistive sheet to form a connection between elements.

The planar resistive elements and wiring patterns are placed on the opposing surfaces of the first resistive sheet (10) and second resistive sheet (20) such that they face each other. Except for the sections where the planar resistive elements and contacts (31b to 36b, 31c to 36c) are, the resistive sheets are attached together using non-conductive adhesive (70). Moreover, an intermediate structure (90) made of small dots is formed between the planar resistive elements (11c, 21c) by printing, etc. Therefore, the contacts (31b to 36b) on the first resistive sheet (10) and the contacts (31c to 36c) on the second resistive sheet (20) are in a free state and become separated from each other so that they are non-conductive, however, when pressed by a fingertip or the like, both contacts come in contact with each other such that they are in a conductive state, and the switch goes ON. In addition, due to the intermediate structure (90), the planar resistive elements (11c, 21c) are also in a free state such that they move away from each other and become non-conductive, however, when pressed by a fingertip or the like, they are put into an electrically conductive state at a position that exceeds a specified load.

The resistive sheet (10, 20) is formed smaller than the circumference of the flange on the top surface side of the upper casing (50), and located in a space that is formed from the flange. As shown in FIG. 6(b), the tail section (40) of the second resistive sheet (20) extends through a notched section that is formed in the actuator (2) toward the bottom inside the casing, and extends through a notched section that is formed in the casing toward the outside of the device, where it is connected to external elements.

In this embodiment, a resistive film system is employed as the digitizer (1), however it is also possible to use a pressure sensitive system. That is, by using pressure-sensitive sheets instead of planar resistive elements, for example, the sheets are non-conductive when in the free state, and it is possible to put the sheets into an electrically conductive state by pressing them to a position that exceeds a specified load.

When the actuator (2) comprises a convex section (3) having dimensions such that, in the free state, the switch structure (5) is in a non-conductive state, and when the digitizer (1) is in a pressed state being pressed by a specified force or greater, the dome spring (4) is pressed and the switch structure (52) is put into a conductive state. The actuator (2) is larger than the inner circumference of the flange of the upper casing (50), is fastened to the digitizer (1) and is rigid.

It is not shown in the figure, however, the dome spring (4) and switch structure (5) can be fastened to the actuator (2) and not fastened to the lower casing (50b).

As shown in FIG. 9, the top surface sheet (30) is fastened to the flange of the upper casing (50) so that it covers the surface on the top side of the upper casing (50). On the top surface side, there is a plurality of surface protrusions (37) that spread out over the range in which a person's fingertip may move, and they are bendable, stretchable, and flexible. These surface protrusions (37) function as keys that are located on the planar resistive elements. Moreover, when necessary, separate keys (41 to 46) are arranged on both sides of the area where the surface protrusions (37) are formed.

It is possible to use well-known electronic materials and electronic parts for any of the sections or parts.

The shape and size of these aforementioned parts can be appropriately changed according to the size, structure, usage of the personal digital assistant or compact electronic device to which they are applied, however by making the thickness of each as thin as possible, construction can be obtained that is made more compact, thinner and more lightweight.

More specifically, a very thin fingertip tactile-sense input device is obtained comprising: a silicon or resin film top surface sheet (30) that has a diameter of 34 mm and thickness of 0.20 mm; a digitizer (1) having a diameter of 27.6 mm and thickness of 0.3 mm; a stainless actuator (2) having a diameter of 31.6 mm and thickness of 0.2 mm; a metal or resin dome spring (4) having a diameter of 5 mm and height of 0.25 mm; for a total thickness of 1.2 mm from the surface of the bottom plate (50b) to the surface of the top surface sheet (30). In this case, the stroke length of the dome spring (4) is 0.2 mm or less, while 14-key input operation suitable for use in the device is capable and a good clicking feel can be obtained.

Of the fingertip tactile-sense input device, the digitizer for a fingertip tactile-sense input device of the present invention will be explained with reference to the drawings.

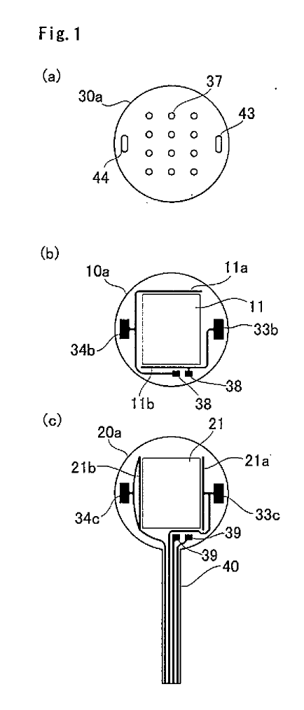

FIG. 1 is a top view of a first embodiment of a digitizer for a fingertip tactile-sense input device of the present invention. This digitizer comprises a first resistive sheet (10a) that is shown in FIG. 1(b), and a second resistive sheet (20a) that is shown in FIG. 1(c). In order to show the relationship with the keys, a top surface sheet (30a) is also shown as a reference in FIG. 1(a).

The top surface sheet (30a), the first resistive sheet (10a) and the second resistive sheet (20a) are shown in the state as seen from the operating side, and are shown in a transparent state where the wiring pattern that appears on the second resistive sheet (20a) is located on the front side in the figure, however, the wiring pattern that appears on the first resistive sheet (10a) is located on the rear side of the drawing.

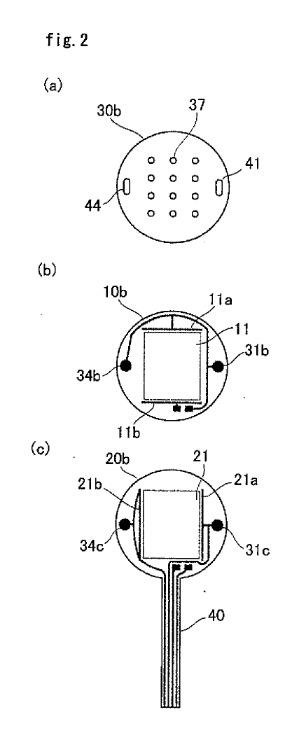

Moreover, in the state shown in the figure, the first resistive sheet (10a) overlaps the second resistive sheet (20a), with square connective pads (38, 39) being electrically connected together, and the digitizer is used with a top surface sheet (30a) placed on top of the first resistive sheet (10a). The same method used in this figure is used in FIG. 2 to FIG. 5, which will be described later.

The digitizer for a fingertip tactile-sense input device of the present invention comprises a first resistive sheet (10a) and a second resistive sheet (20a), and in order that it is set into a conductive state at a position that exceeds a specified load, an intermediate structure (90) is located in between planar resistive elements (11c, 21c) that are formed on the first resistive sheet (10a) and second resistive sheet (20a) in a square or rectangular control area (11, 21) that is surrounded by a top edge, right edge, bottom edge and left edge.

The first resistive sheet (10a) can be made of resin such as flexible PET (polyethylene terephthalate) so that it can be deformed by a person's finger. The second resistive sheet (20a) can be the same as the first resistive sheet (10a), or could be any well-known electronic material or electronic parts, such as PCB (printed-circuit board).

A square or rectangular first planar resistive element (11c) that is the same size as or larger than the control area (11) is attached to the first resistive sheet (10a) at or over the control area (11) on the side which opposes or faces the second resistive sheet (20a), and a square or rectangular second planar resistive element (21c) that is the same size as the first planar resistive element (11c) is attached to the second resistive sheet (20a) at or over the control area (21) on the side which opposes or faces the first resistive sheet (10a). Moreover, the top edge of the first planar resistive element (11c) is connected to a top edge electrode (11a), the bottom edge of the first planar resistive element (11c) is connected to a bottom edge electrode (11b), the right edge of the second planar resistive element (21c) is connected to a right edge electrode (21a), and the left edge of the second resistive element (21c) is connected to a left edge electrode (21b).

The intermediate structure (90) is a structure in which insulation sections are dispersed in a patchy or random shape, and at a position where the space between the insulation sections is pressed down, the first planar resistive element (11c) and second planar resistive element (21c) conduct.

It is also possible to use a commercially sold pressure-sensitive sheet, which conducts due to a load, for the planar resistive elements (11c, 21c) or the intermediate structure (90).

A first right contact (33b) and a second right contact (33c) that make up a right switch (33) are located on the first resistive sheet (10a) and second resistive sheet (20a), respectively at specified positions that are separated to the right from the control areas (11, 21) such that they face each other, where the first right contact (33b) is connected to the bottom edge electrode (11b), and the second right contact (33c) is connected to the right edge electrode (21a).

A first left contact (34b) an a second left contact (34c) that make up a left switch (34) are located on the first resistive sheet (10a) and second resistive sheet (20a), respectively at specified positions that are separated to the left from the control areas (11, 21) such that they face each other, where the first left contact (34b) is connected to the top edge electrode (11a), and the second left contact (34c) is connected to the left edge electrode (21b).

The fingertip tactile-sense input device is formed by overlapping the digitizer for a fingertip tactile-sense input device of the present invention that is wired as described above with a top surface sheet (30a) that comprises surface protrusions (37), and connecting the wiring of the tail section (40) to a commercially sold touch panel controller IC (For example, DMC Co., LTD., Model TSC-10/IC) (not shown in the figure) or to a controller IC having similar functions.

With the controller IC, when the right switch (33) is in a conductive state, this is the same as when the lower right corners of the planar resistive elements (11c, 21c) are in a conductive state, and it is possible to obtain output of a signal that is recognized as the lower right position that is separated from the control areas (11, 21). On the other hand, when the left switch (34) is in the conductive state, this is the same as when the upper left corners of the planar resistive elements (11c, 21c) are in a conductive state, and it is possible to obtain output of a signal that is recognized as the upper left position that is separated from the control areas (11, 21). This is displayed in the layout on the display so that it corresponds with the actual key position.

This will be explained in further detail using FIG. 1 to FIG. 10. Key positions that correspond to the surface protrusions (37) on the top surface sheet (30a) are assigned to each of the specified positions in the control areas (11, 21). For example, the number keys 1 to 0 (ten key), and the ‘*’ and ‘#’ keys are assigned to the surface protrusions (37). It is also possible for alphabet keys by 12 characters to be assigned to the protrusions (37). On the other hand, the ‘Backspace’ key is assigned to the right switch (33), and the ‘Enter’ key is assigned to the left switch (34). Changing these screens is processed by an application that is executed by pressing the ‘Backspace’ key for an extended period, for example.

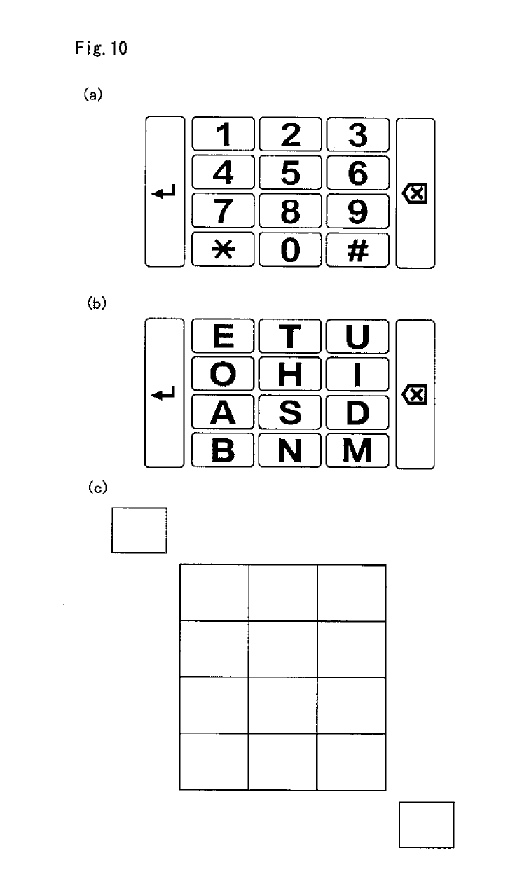

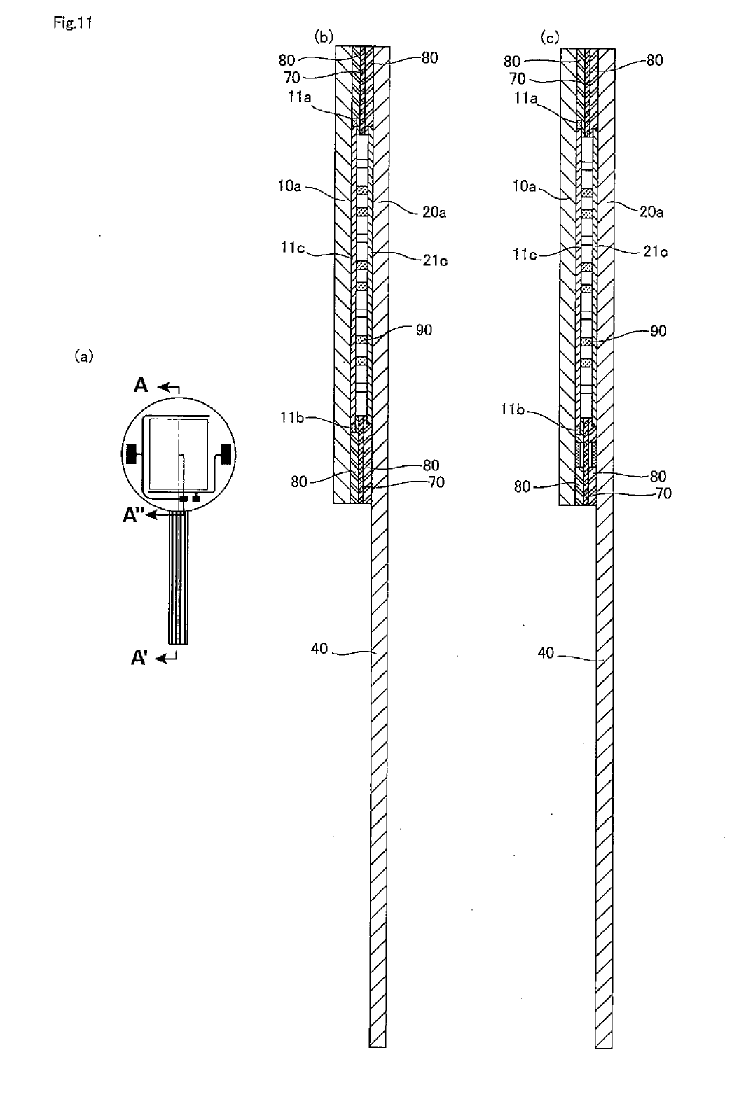

In FIG. 10(a) and (b), the state in which these key arrangements are displayed on the display of a compact electronic device is shown. For example, in the case of a mobile telephone, the telephone number input mode is the ten-key mode state as shown in FIG. 10(a). In the case where there is a top surface sheet (30a), when a fingertip is brought in contact with the upper left inside the control area using the surface protrusions (37) as a guide, and that position corresponds to the position of the ‘1’ key, the IC displays on the display that input of the ‘1’ key has been selected. After that, when that position is pressed even more with the fingertip, the convex section (3) in the center of the actuator (2) presses the spring dome (4) from pressure from any position as shown in FIG. 9, and together with creating a clicking feel, the switch mechanism (5) conducts and the input is set.

For example, when the ‘Backspace’ key is input in order to change the input mode, by using the fingertip to touch the right key (43) on the top surface sheet (30a), the controller IC recognizes the signal as when the lower right corners of the planar resistive elements are in a conductive state. More specifically, in FIG. 10(c), the controller IC recognizes that there was input in the area of the lower right position that is separated from the control area. From this, in FIG. 10(a) and (b), it is displayed that the ‘Backspace’ key was selected. In that state, by pressing the area further, then as described above, that input is set.

In the embodiment shown in the figures, the planar resistive elements (11c, 21c) are larger than the control area (11, 21) so the right switch (33) and the left switch (34) are recognized as being outside the control area (11, 21), and in an application making a clear distinction becomes easy. Alternatively, in the case where the planar resistive elements (11c, 21c) are the same size as the control area (11, 21), the right switch (33) and left switch (34) are recognized as being a corner of the control area (11, 21), and in this case as well, by performed appropriate processing in an application, it becomes possible to use these keys.

FIG. 2 is a top view of a second embodiment of a digitizer for a fingertip tactile-sense input device of the present invention, and shows a first resistive sheet (10b) and second resistive sheet (20b). Similarly, the top surface sheet (30b) is also shown. The parts that are different from the embodiment shown in FIG. 1 will be explained below.

On both the first resistive sheet (10b) and second resistive sheet (20b) there is a first right contact (31b) and second right contact (31c) that are separated to the right from the control areas (11, 21) and are arranged such that they face each other to form a right switch (31), with the first right contact (31b) being connected to a top edge electrode (11a) and the second right contact (31c) being connected to a right side electrode (21a).

On both the first resistive sheet (10b) and second resistive sheet (20b) there is a first left contact (34b) and second left contact (34c) that are separated to the left from the control areas (11, 21) and are arranged such that they face each other to form a left switch (34), with the first left contact (34b) being connected to a top edge electrode (11a) and the second left contact (34c) being connected to a left side electrode (21b).

With the touch controller IC, when the right switch (33) is in the conductive state, this is the same as when the upper right corners of the planar resistive elements (11c, 21c) are in the conductive state, and it is possible to obtain output of a signal that is recognized as the upper right position that is separated from the control areas (11, 21). On the other hand, when the left switch (34) is in the conductive state, this is the same as when the upper left corner of the planar resistive elements (11c, 21c) are in the conductive state, and it is possible to obtain a signal that is recognized as the upper left position that is separated from the control areas (11, 21).

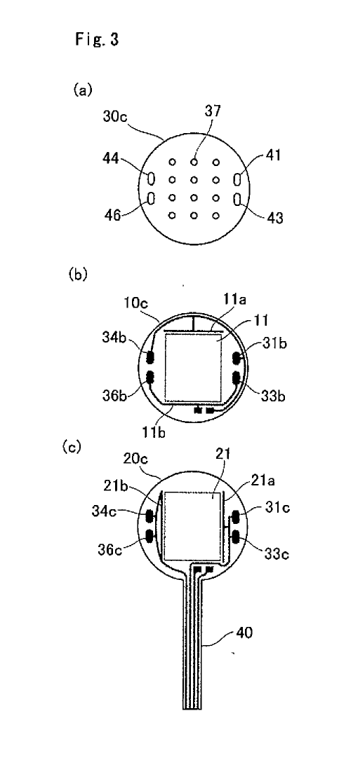

FIG. 3 is a top view of a third embodiment of a digitizer for a fingertip tactile-sense device of the present invention, and shows a first resistive sheet (10c) and second resistive sheet (20c). Similarly, a top surface sheet (30c) is also shown. The parts that are different from the embodiment shown in FIG. 1 will be explained below. In this embodiment, there are two right switches and two left switches, with keys being provided that correspond to the four switches.

On both the first resistive sheet (10c) and second resistive sheet (20c), there is a first upper right contact (31b) and second upper right contact (31c) that are located in specified positions that are separated to the upper right from the control areas (11, 21) and arranged so that they face each other to form an upper right switch (31), with the first upper right contact (31b) being connected to an top edge electrode (11a), and the second upper right contact (31c) being connected to a right edge electrode (21a).

On both the first resistive sheet (10c) and second resistive sheet (20c), there is a first lower right contact (33b) and second lower right contact (33c) that are located in specified positions that are separated to the lower right from the control areas (11, 21) and arranged so that they face each other to form a lower right switch (33), with the first lower right contact (33b) being connected to a bottom edge electrode (11b), and the second lower right contact (33c) being connected to a right edge electrode (21a).

On both the first resistive sheet (10c) and second resistive sheet (20c), there is a first upper left contact (34b) and second upper left contact (34c) that are located in specified positions that are separated to the upper left from the control areas (11, 21) and arranged so that they face each other to form an upper left switch (34), with the first upper left contact (34b) being connected to a top edge electrode (11a), and the second upper left contact (34c) being connected to a left edge electrode (21b).

On both the first resistive sheet (10c) and second resistive sheet (20c), there is a first lower left contact (36b) and second lower left contact (36c) that are located in specified positions that are separated to the lower left from the control areas (11, 21) and arranged so that they face each other to form a lower left switch (36), with the first lower left contact (36b) being connected to a bottom edge electrode (11b), and the second lower left contact (36c) being connected to a left edge electrode (21b).

With the touch panel controller IC, when the upper right switch (31) is in the conductive state, this is the same as when the upper right corner of the planar resistive elements (11c, 21c) are in the conductive state, and it is possible to obtain output of a signal that is recognized as an upper right position that is separated from the control areas (11, 21). On the other hand, when the lower right switch (33) is in the conductive state, this is the same as when the lower right corner of the planar resistive elements (11c, 21c) are in the conductive state, and it is possible to obtain output of a signal that is recognized as a lower right position that is separated from the control areas (11, 21). Similarly, for the upper left switch (34) and lower left switch (36), it is possible to obtain signals that are recognized as upper left and lower left positions that are separated from the control areas (11, 21).

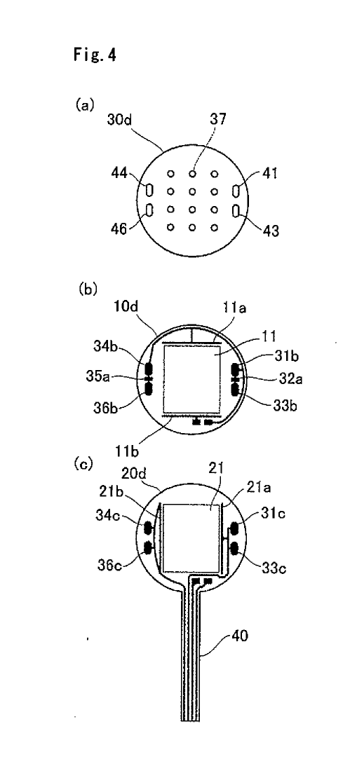

FIG. 4 is a top view of a fourth embodiment of a digitizer for a fingertip tactile-sense input device of the present invention that shows a first resistive sheet (10d) and second resistive sheet (20d). Similarly, a top surface sheet (30d) is shown. The parts that are different from those of the embodiment shown in FIG. 1 are explained below. In this embodiment, there are two right switches and two left switches, with keys being provided that correspond to the four switches.

On both the first resistive sheet (10d) and second resistive sheet (20d), there is a first upper right contact (31b) and second upper right contact (31c) that are located in specified positions that are separated to the upper right from the control areas (11, 21) and arranged so that they face each other to form an upper right switch (31), with the first upper right contact (31b) being connected to an top edge electrode (11a), and the second upper right contact (31c) being connected to a right edge electrode (21a).

On both the first resistive sheet (10d) and second resistive sheet (20d), there is a first lower right contact (33b) and second lower right contact (33c) that are located in specified positions that are separated to the lower right from the control areas (11, 21) and arranged so that they face each other to form a lower right switch (33), with the first lower right contact (33b) being connected to an upper right contact (31b) via a right resistance (32a), and the second lower right contact (33c) being connected to a right edge electrode (21a).

On both the first resistive sheet (10d) and second resistive sheet (20d), there is a first upper left contact (34b) and second upper left contact (34c) that are located in specified positions that are separated to the upper left from the control areas (11, 21) and arranged so that they face each other to form an upper left switch (34), with the first upper left contact (34b) being connected to a top edge electrode (11a), and the second upper left contact (34c) being connected to a left edge electrode (21b).

On both the first resistive sheet (10d) and second resistive sheet (20d), there is a first lower left contact (36b) and second lower left contact (36c) that are located in specified positions that are separated to the lower left from the control areas (11, 21) and arranged so that they face each other to form a lower left switch (36), with the first lower left contact (36b) being connected to the first upper left contact (34b) via a left resistance (35a), and the second lower left contact (36c) being connected to a left edge electrode (21b).

Particularly, by making the resistance values of both the right resistance (32a) and the left resistance (35a) match the resistance values of the first planar resistive element (11) that is measured between the top edge electrode (11a) and the bottom edge electrode (11b), from the touch panel controller IC it is possible to obtain output of a signal in which the upper right switch (31), lower right switch (33), upper left switch (34) and lower left switch (36) are recognized as a corner of the planar resistive element. With the aforementioned IC, a display can be displayed at an arbitrary position on the display that corresponds to the keys. For example, not only is it possible to arrange the two keys on both sides of the other 12 keys on the display, but the 4 keys could also be arranged in a row at the top of the 12 keys.

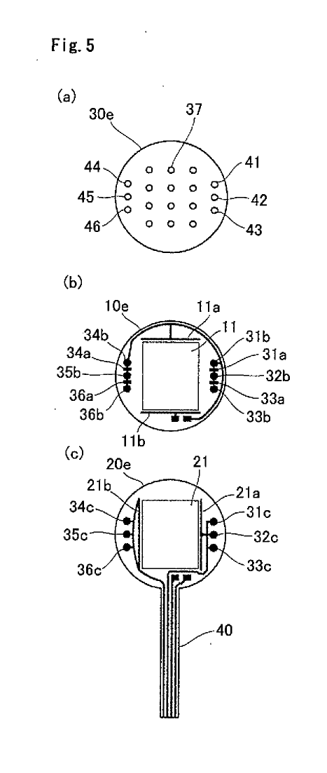

FIG. 5 is a top view of a fifth embodiment of a digitizer for a fingertip tactile-sense input device of the present invention, and shows a first resistive sheet (10e) and second resistive sheet (20e). Similarly, a top cover sheet (30e) is also shown. The parts that are different from those of the embodiment shown in FIG. 1 are explained below. In this embodiment, there are three right switches and three left switches, with keys being provided that correspond to the six switches.

On both the first resistive sheet (10e) and second resistive sheet (20e), there is a first upper right contact (31b) and second upper right contact (31c) that are located in specified positions that are separated to the upper right from the control areas (11, 21) and arranged so that they face each other to form an upper right switch (31), with the first upper right contact (31b) being connected to an top edge electrode (11a), and the second upper right contact (31c) being connected to a right edge electrode (21a).

On both the first resistive sheet (10e) and second resistive sheet (20e), there is a first middle right contact (32b) and second middle right contact (32c) that are located in specified positions that are separated to the middle right from the control areas (11, 21) and arranged so that they face each other to form a middle right switch (32), with the first middle right contact (32b) being connected to the first upper right contact (31b) via an upper right resistance (31a), and the second middle right contact (32c) being connected to a right edge electrode (21a).

On both the first resistive sheet (10e) and second resistive sheet (20e), there is a first lower right contact (33b) and second lower right contact (33c) that are located in specified positions that are separated to the lower right from the control areas (11, 21) and arranged so that they face each other to form a lower right switch (33), with the first lower right contact (33b) being connected to the first middle right contact (32b) via a lower right resistance (33a), and the second lower right contact (33c) being connected to a right edge electrode (21a).

On both the first resistive sheet (10e) and second resistive sheet (20e), there is a first upper left contact (34b) and second upper left contact (34c) that are located in specified positions that are separated to the upper left from the control areas (11, 21) and arranged so that they face each other to form an upper left switch (34), with the first upper left contact (34b) being connected to a top edge electrode (11a), and the second upper left contact (34c) being connected to a left edge electrode (21b).

On both the first resistive sheet (10e) and second resistive sheet (20e), there is a first middle left contact (35b) and second middle left contact (35c) that are located in specified positions that are separated to the middle left from the control areas (11, 21) and arranged so that they face each other to form a middle left switch (35), with the first middle left contact (35b) being connected to the first upper left contact (34b) via an upper left resistance (34a), and the second middle left contact (35c) being connected to a left edge electrode (21b).

On both the first resistive sheet (10e) and second resistive sheet (20e), there is a first lower left contact (36b) and second lower left contact (36c) that are located in specified positions that are separated to the lower left from the control areas (11, 21) and arranged so that they face each other to form a lower left switch (36), with the first lower left contact (36b) being connected to the first middle left contact (35b) via a lower left resistance (36a), and the second lower left contact (36c) being connected to a left edge electrode (21b).

Particularly, by making the resistance value of the upper right resistance (31a), lower right resistance (33a), upper left resistance (34a) and lower left resistance (36a) half the resistance value of the first planar resistive element (11c) that is measured between the top edge electrode (11a) and the bottom edge electrode (11b), from the touch panel controller IC it is possible to obtain output of a signal in which the upper right switch (31), lower right switch (33), upper left switch (34) and lower left switch (36) are recognized as corners of the planar resistive element; the middle right switch (32) is recognized as being in between the upper right switch (31) and the lower right switch (33), and the middle left switch (35) is recognized as being in between the upper left switch (34) and lower left switch (36).

With the aforementioned IC, a display can be displayed at an arbitrary position on the display that corresponds to the keys. For example, not only is it possible to arrange three keys on both sides of the other 12 keys on the display, but the keys could also be arranged in two rows of three at the top of the 12 keys.

FIG. 11 shows an example of the first embodiment of a digitizer for a fingertip tactile-sense input device of the present invention which is shown in FIG. 1, wherein FIG. 11(a) is a top view thereof, FIG. 11(b) is a cross sectional view thereof along the line A-A′, and FIG. 11(c) is a cross sectional view thereof along the line A-A′ which includes a section along the line A-A″ partly. The first resistive sheet (10a) and the second resistive sheet (11b) are bonded with each other on a section other than the area where the control areas (11, 21), the switches (33, 34) and the connective pads (38, 39) are formed, with using non-conductive adhesive (70) via resistant materials (80). Also, the planar resistive elements (11c, 21c) are arranged into position on the opposing surface of the first and second resistive sheets (10a, 20a). The opposing surfaces of the planar resistive elements (11c, 21c) are spaced-apart via a plurality of spacers (90) as an intermediate structure, which is printed on the opposing surface of the second planar resistive element (21c).

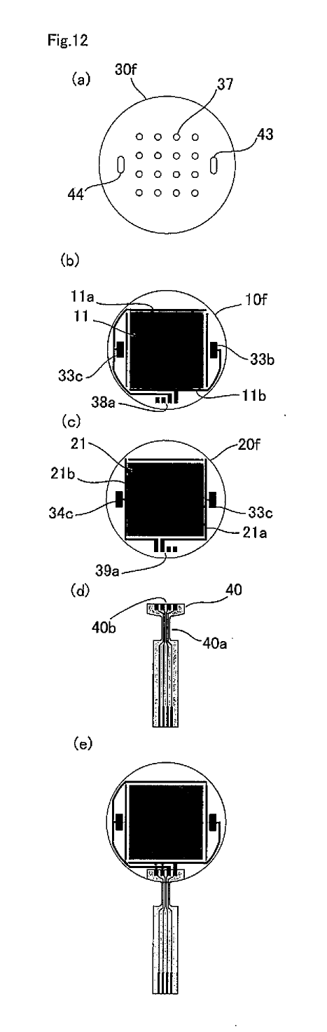

Also, FIG. 12 shows an example of another embodiment of a digitizer for a fingertip tactile-sense input device of the present invention, wherein FIG. 12(a) shows a top view of a top surface sheet (30f) thereof, FIG. 12(b) shows a top view of a first resistive sheet (10f) thereof, FIG. 12(c) shows a top view of a second resistive sheet (20f) thereof, FIG. 12(d) shows a tail section (40) thereof which is an element separated from the second resistive sheet (20f), and FIG. 12(e) shows a state where the first resistive sheet (10f), the second resistive sheet (20f) and the tail section (40) are assembled.

In this embodiment, both the vertical and horizontal dimension of the control areas (11, 21) is larger than the other embodiments. Also, the tail section (40) is formed as an element separated from the second resistive sheet (20f) unlike with the other embodiments. By sandwiching an end of the tail section (40) which is on the internal side of the device between a part of the first resistive sheet (10f) and a part of the second resistive sheet (20f) where terminations of the wiring patterns formed on the opposing surface of the first and second resistive sheets (10f, 20f), the tail section (40) is attached to the first and second resistive sheets (10f, 20f). The required number of electrode pads (38a, 39a, 40b, 40c) are provided on each of terminations of the respective wiring patterns of the first and second resistive sheets (10f, 20f) and the both sides of the one end of the tail section (40), and the electrode pads which face each other are connected electrically to each other.

It is preferred that the tail section (40) is a flexible substrate, and a part (40a) of the tail section (40) which is adjacent or near to the connecting section with the first and second resistive sheets (10f, 20f) is constricted and has a width narrower than the other part as shown in FIG. 12(d).

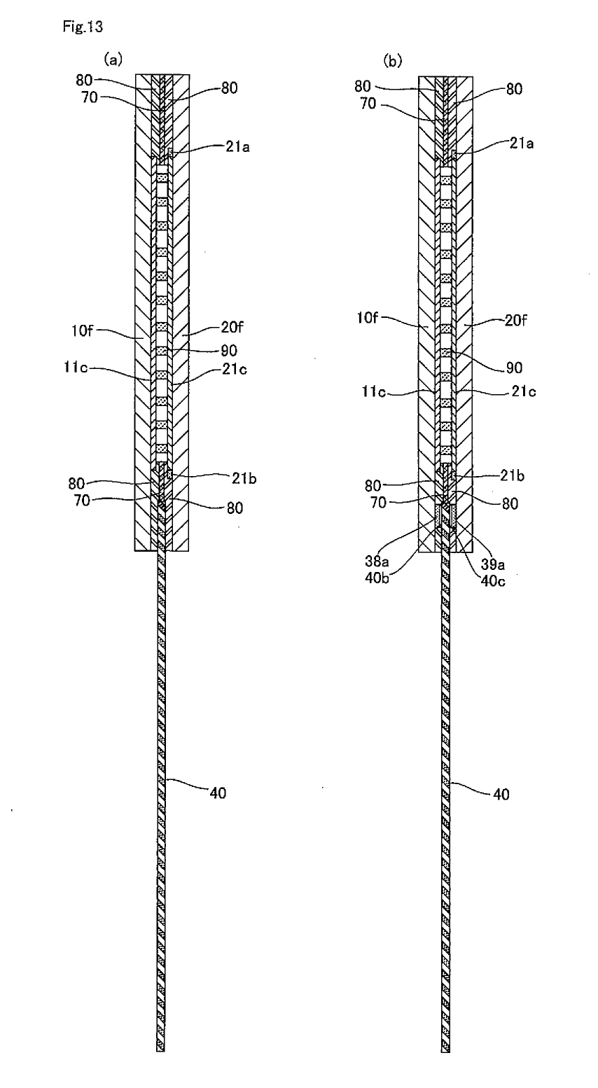

FIG. 13(a) shows a cross sectional view of the embodiment of a digitizer for a fingertip tactile-sense input device of the present invention which is shown in FIG. 12, and FIG. 13(b) is another cross sectional view thereof similar to FIG. 13(a) but it includes partly a section where the connecting section of the electrode pads (38a, 39a, 40b, 40c) are formed.

The devices of this embodiments can be manufactured with high productivity and low cost, and they have high durability and flexibility, which are also within the scope of the present invention.

1. A digitizer for a fingertip tactile-sense input device comprises: two resistive sheets positioned so as to face each other; planar resistive elements that are arranged on opposing surfaces of the two resistive sheets; contacts that are formed on opposing surfaces of the two resistive sheets at locations where the planar resistive elements are not arranged; electrodes that are attached to each of the two opposing edges of the planar resistive elements such that the current direction is perpendicular to each other; and a wiring pattern that connects the contacts and electrodes to external elements;
wherein the planar resistive elements face each other via an intermediate structure such that they are in an electrically conductive state at a position that exceeds a specified load, and the wiring pattern is formed so that, when at least one of the contact conducts current, an electrical response is obtained that is the same as when one of the four corners of the planar resistive elements or any specified position along the four edges is in a conductive state.

2. A digitizer for a fingertip tactile-sense input device comprises; two resistive sheets, with an intermediate structure being placed between the resistive sheets in a square or rectangular control area so that the resistive sheets are in an electrically conductive state at a position that exceeds a specified load,
wherein a square or rectangular planar resistive element that is the same size as or larger than the control area is attached to each of the resistive sheets at the control area on the opposing side,
two electrodes are attached to each of the planar resistive elements on two opposing edges so that the current direction is perpendicular to each other, and
one or more contacts are arranged on each of the resistive sheets at specified positions that are separated from the control area, and the wiring is arranged such that by controlling at least one of the contacts, an electrical response is obtained that is the same as when one of the four corners or any specified position along the four edges of the planar resistive elements is in a conductive state.

3. A digitizer for a fingertip tactile-sense input device comprises: a first resistive sheet and a second resistive sheet, with an intermediate structure being placed between in a square or rectangular control area of the first and second resistive sheet that is surrounded by a top edge, right edge, bottom edge and left edge so that they are in an electrically conductive state at a position that exceeds a specified load;
wherein a square or rectangular first planar resistive element that is the same size as or larger than the control area is attached to the first resistive sheet at the control area on a side that faces the second resistive sheet, and a square or rectangular second planar resistive element that is the same size as or larger than the control area is attached to the second resistive sheet at the control area on a side that faces the first resistive sheet;
with a top edge electrode being attached to the top edge of the first planar resistive element, a bottom edge electrode being attached to the bottom edge of the first planar resistive element, a right edge electrode being attached to the right edge of the second planar resistive element, and a left edge electrode being attached to the left edge of the second planar resistive element; and
one or more contacts are placed on both the first resistive sheet and second resistive sheet at specified positions separated from the control area so that they form a switch, and a wiring pattern for connecting the electrodes and contacts with external elements is formed so that by controlling the switch/switches an electrical response is obtained that is the same as when one of the four corners or any specified position along the four edges of the planar resistive elements is in a conductive state.

4. The digitizer for a fingertip tactile-sense input device according to claim 3, wherein the intermediate structure is a structure in which insulation sections are dispersed in a patchy or random shape, and at a position where the space between the insulation sections is pressed down, the first planar resistive element and second planar resistive element conduct.

5. The digitizer for a fingertip tactile-sense input device according to claim 3, wherein the intermediate structure is a structure that conducts when pressed.

6. The digitizer for a fingertip tactile-sense input device according to claim 3, wherein the switches comprise a lower right switch and an upper left switch,
wherein a first lower right contact and a second lower right contact are placed respectively on the first resistive sheet and second resistive sheet at specified positions that are separated to the right from the control area such that they face each other to form the lower right switch, with the first lower right contact being connected to the bottom edge electrode and the second lower right contact being connected to the right edge electrode; and
a first upper left contact and a second upper left contact are placed respectively on the first resistive sheet and second resistive sheet at specified positions that are separated to the left from the control area such that they face each other to form the upper left switch, with the first upper left contact being connected to the top edge electrode and the second upper left contact being connected to the left edge electrode.

7. The digitizer for a fingertip tactile-sense input device according to claim 3, wherein the switches comprise an upper right switch and an upper left switch,
wherein a first upper right contact and a second upper right contact are placed respectively on the first resistive sheet and second resistive sheet at specified positions that are separated to the right from the control area such that they face each other to form the upper right switch, with the first upper right contact being connected to the top edge electrode and the second upper right contact being connected to the right edge electrode; and
a first upper left contact and a second upper left contact are placed respectively on the first resistive sheet and second resistive sheet at specified positions that are separated to the left from the control area such that they face each other to form the upper left switch, with the first upper left contact being connected to the top edge electrode and the second upper left contact being connected to the left edge electrode.

8. The digitizer for a fingertip tactile-sense input device according to claim 3, wherein the switches comprise an upper right switch, a lower right switch, an upper left switch and a lower left switch,
wherein a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode and the second upper right contact being connected to the right edge electrode;
a first lower right contact and a second lower right contact are placed respectively on the first resistive sheet and second resistive sheet at specified positions that are separated to the lower right from the control area such that they face each other to form the lower right switch, with the first lower right contact being connected to the bottom edge electrode and the second lower right contact being connected to the right edge electrode;
a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode and the second upper left contact being connected to the left edge electrode; and
a first lower left contact and a second lower left contact are placed respectively on the first resistive sheet and second resistive sheet at specified positions that are separated to the lower left from the control area such that they face each other to form the lower left switch, with the first lower left contact being connected to the bottom edge electrode and the second lower left contact being connected to the left edge electrode.

9. The digitizer for a fingertip tactile-sense input device according to claim 3, wherein the switches comprise an upper right switch, a lower right switch, an upper left switch and a lower left switch,
wherein a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode and the second upper right contact being connected to the right edge electrode;
a first lower right contact and a second lower right contact are placed respectively on the first resistive sheet and second resistive sheet at specified positions that are separated to the lower right from the control area such that they face each other to form the lower right switch, with the first lower right contact being connected to the first upper right contact via a right resistance, and the second lower right contact being connected to the right edge electrode;
a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode, and the second upper left contact being connected to the left edge electrode; and
a first lower left contact and a second lower left contact are placed respectively on the first resistive sheet and second resistive sheet at specified positions that are separated to the lower left from the control area such that they face each other to form the lower left switch, with the first lower left contact being connected to the first upper left contact via a left resistance, and the second lower left contact being connected to the left edge electrode.

10. The digitizer for a fingertip tactile-sense input device according to claim 3, wherein the switches comprise an upper right switch, a middle right switch, a lower right switch, an upper left switch, a middle left switch and a lower left switch,
wherein a first upper right contact and a second upper right contact are placed respectively on the first resistive sheet and second resistive sheet at specified positions that are separated to the upper right from the control area such that they face each other to form the upper right switch, with the first upper right contact being connected to the top edge electrode, and the second upper right contact being connected to the right edge electrode;
a first middle right contact and a second middle right contact are placed respectively on the first resistive sheet and second resistive sheet at specified positions that are separated to the middle right from the control area such that they face each other to form the middle right switch, with the first middle right contact being connected to the first upper right contact via an upper right resistance, and the second middle right contact being connected to the right edge electrode;
a first lower right contact and a second lower right contact are placed respectively on the first resistive sheet and second resistive sheet at specified positions that are separated to the lower right from the control area such that they face each other to form the lower right switch, with the first lower right contact being connected to the first middle right contact via a lower right resistance, and the second lower right contact being connected to the right edge electrode;
a first upper left contact and a second upper left contact are placed respectively on the first resistive sheet and second resistive sheet at specified positions that are separated to the upper left from the control area such that they face each other to form the upper left switch, with the first upper left contact being connected to the top edge electrode and the second upper left contact being connected to the left edge electrode;
a first middle left contact and a second middle left contact are placed respectively on the first resistive sheet and second resistive sheet at specified positions that are separated to the middle left from the control area such that they face each other to form the middle left switch, with the first middle left contact being connected to first upper left contact via an upper left resistance, and the second middle left contact being connected to the left edge electrode; and
a first lower left contact and a second lower left contact are placed respectively on the first resistive sheet and second resistive sheet at specified positions that are separated to the lower left from the control area such that they face each other to form the lower left switch, with the first lower left contact being connected to the middle left contact via a lower left resistance, and the second lower left contact being connected to the left edge electrode.

11. The digitizer for a fingertip tactile-sense input device according to claim 1, wherein the digitizer for a fingertip tactile-sense input device of the present invention further comprises; a tail section having one end of the length direction that is sandwiched between and fixed to a part of the first resistive sheet and a part of the second resistive sheet; and a required number of electrode pads provided on each of terminations of the respective wiring patterns of the first resistive sheet and second resistive sheet and the both sides of the one end of the tail section, the electrode pads which face each other being connected electrically to each other.

12. The digitizer for a fingertip tactile-sense input device according to claim 1, wherein the tail section is a flexible substrate, and wherein a part of the tail section which is adjacent or near to the connecting section with the first resistive sheet and second resistive sheet has a width narrower than the other part.

13. The digitizer for a fingertip tactile-sense input device according to claim 1, further comprising a top surface sheet, which outputs information about (1) the position that is pressed the hardest, and (2) the operated key.

14. The fingertip tactile-sense input device according to claim 13, wherein the device is for use in a mobile telephone.

15. The fingertip tactile-sense input device according to claim 13, wherein the device is for use in a personal digital assistance device.

16. The fingertip tactile-sense input device according to claim 13, wherein the device is for use in an input device for a personal computer.

17. The fingertip tactile-sense input device according to claim 13, wherein the device is for use with a household electrical appliance.

18. The fingertip tactile-sense input device according to claim 13, wherein the device is for use in a remote controller.

19. The fingertip tactile-sense input device according to claim 13, wherein the device is for use in a gaming device.

20. The fingertip tactile-sense input device according to claim 13, wherein the device is for use in a medical device.
